(19) United States
(12) Patent Application Publication
(10) Pub. No.: US 2026/0145624 A1
(43) Pub. Date: May 28, 2026

(54) SYSTEM FOR CONNECTING A DEVICE TO THE FRONT OF A MOTOR VEHICLE

(71) Applicant: Integrity Auto Group Inc., Westminster, MD (US)

(72) Inventor: Adam Andrew FODOR, Hanover, PA (US)

(73) Assignee: Integrity Auto Group Inc., Westminster, MD (US)

(21) Appl. No.: 19/400,692

(22) Filed: Nov. 25, 2025

Related U.S. Application Data
(60) Provisional application No. 63/725,677, filed on Nov. 27, 2024.
(60) Provisional application No. 63/757,833, filed on Feb. 13, 2025.

(51) Int. Cl. B60R 11/04; B60Q 1/18; B60R 13/10

(52) U.S. Cl. CPC B60R 11/04; B60Q 1/18; B60R 13/105

(57) ABSTRACT

A system for connecting a device to the front of a motor vehicle includes at least a first mounting bracket. The first mounting bracket configured to connect to a first chassis surface of the motor vehicle or a first mounting surface of a secondary component. The device being selected from the group consisting of a bull bar, a license plate holder, a D-ring, a light bar, a bumper mount, a recovery hook, a light pod, a hitch receiver, a flag mount, a camera mount, a fishing pole holder, a bicycle holder, a step, a cargo basket, a tie down point, a jerry can, a spare tire mount, a winch, a wireless internet transmitter, a solar panel, a light pole, a pet containment anchor, an awning, an umbrella stand, a table, a hammock, a seating device, a sink device, a grill, a vise, a shower module, or a toilet module and combinations thereof.

### CROSS REFERENCES AND PRIORITIES

This Application claims priority from U.S. Provisional Application No. 63/725,677 filed on 27 Nov. 2024 and U.S. Provisional Application No. 63/757,833 filed on 13 Feb. 2025, the teachings of each of which are incorporated by reference herein in their entirety.

### BACKGROUND

Trucks—including light duty pickup trucks, sport utility vehicles, and other vehicles are typically fitted with a grill at the front to allow for air intake and engine cooling. In many implementations, these grills have aesthetic properties as well as functional properties. However, front grills may become damaged by road debris, animal strikes, and other collisions—often leading to significant repair costs. Often, vehicle owners will customize the front fascia of their vehicle with a variety of devices such as bull bars, lighting elements, winches, custom license plate holders, and the like.

Bull bars—sometimes referred to as grill guards have been installed on the fronts of many vehicles to reduce or prevent damage to the vehicle's front grill. Typically, a bull bar will incorporate a number of rigid bar members fabricated of steel, aluminum, or similar materials which connect to and extend from the vehicle's front bumper, grill, or other portions of the vehicle's front fascia. The rigidity of the bull bar—extended forward from the vehicle's grill—absorbs impacts from road debris, animal strikes, and other collisions—which reduces or prevents damage to the vehicle's front grill.

One such bull bar is disclosed in U.S. Pat. No. 4,469,360 to Drury which describes a vehicle bull-bar or fender of the kind comprising an array of fender bars mounted on a pair of upright stanchions fixed by their lower-ends to the front of the vehicle, has a C-shaped fender bar freely insertable and through holes in the tops of the stanchions and has its ends removably secured to the stanchions intermedially of their ends. One or more other fender bars extend between the stanchions parallel to and out of axial alignment with any part of said C-shaped fender bar. The ends of the other fender bar (or bars) are removably secured to the stanchions.

In practice, existing bull bars, lighting elements, winches, and other devices are often cumbersome to install—requiring modification to the vehicle's bumper, grill, front chassis members, and the like. In doing so, additional features of the vehicle—such as clevises, D-rings, and the like which may assist in vehicle recovery, particularly during off-road recreational use—are often eliminated from the vehicle in favor of the added device. Modification to the vehicle's bumper and/or chassis may be particularly dangerous as it may negatively affect safety performance during high speed impacts.

The need exists, therefore, for an improved system for connecting a device to the front of a vehicle without requiring modification to the vehicle's chassis and without eliminating other features of the vehicle such as clevises, D-rings and the like.

### SUMMARY

Described herein is a system for connecting a device to the front of a motor vehicle. The system includes a first mounting bracket. The first mounting bracket configured to connect to a first chassis surface of the motor vehicle or a first mounting surface of a secondary component.

In certain embodiments, the first mounting bracket may include a first mid-plate, a first bottom plate, and a first top plate. The first bottom plate may extend downwardly from a first mid-plate lower edge and may have at least one first bottom plate mounting hole configured to connect the first clevis to the first mounting bracket. The first top plate may extend upwardly from at first mid-plate upper edge and may have at least one first top plate mounting hole configured to connect to the first mounting surface.

In some embodiments, the secondary component may be a first adapter configured to connect to the first chassis surface the motor vehicle and having the first mounting surface. When present, the first adapter may include a first central plate, a first adapter upper plate, a first adapter upward facing tab, a first adapter downward facing tab, a first adapter second downward facing tab, a first adapter lower plate, and a first adapter lower mounting panel. The first central plate may include a plurality of first clevis mounting holes configured to connect the first clevis to the first central plate. The first adapter upper plate may extend inwardly from a first central plate upper edge. The first adapter upward facing tab may extend upwardly from a first adapter upper plate terminal edge and may form the first mounting surface. The first adapter first downward facing tab may extend downwardly from a first adapter upper plate terminal edge first end and may include at least one first adapter first downward facing tab mounting hole. The first adapter second downward facing tab may extend downwardly from a first adapter upper plate terminal edge second end and may have at least one first adapter second downward facing tab mounting hole. The first adapter lower plate may extend inwardly from a first central plate lower edge. The first adapter lower mounting panel may extend downwardly from a first adapter lower plate terminal edge and may have at least one first adapter lower mounting panel mounting hole.

In some embodiments, the device may include a license plate bracket. The license plate bracket may be connected to and extending from the first adapter. In addition to, or instead of, a license plate bracket, the device may include a light pod connected to and extending from the first adapter.

In certain embodiments, the secondary component may include a first clevis connected between the first adapter and the first mounting bracket. In some such embodiments, the device may include a first D-ring connected to the first clevis. In certain embodiments, the first adapter, the first mounting bracket, and the first clevis may be integrally connected to one another.

In some embodiments, the system may further include a second adapter, a second mounting bracket, and a second clevis. When present, the second adapter may be configured to connect to a second chassis surface of the motor vehicle and may have a second mounting surface. When present, the second mounting bracket may be configured to connect to the second mounting surface. When present, the second clevis may be connected between the second adapter and the second mounting bracket. In some embodiments, the second adapter, the second mounting bracket, and the second clevis may be integrally connected to one another.

In certain embodiments, the device may include a second D-ring connected to the second clevis. In addition to, or instead of, a second D-ring, the device may include a light bar connected to and extending between the first adapter and the second adapter.

In some embodiments, the device may be selected from the group consisting of a bull bar, a license plate holder, a D-ring, a light bar, a bumper mount, a recovery hook, a light pod, a hitch receiver, a flag mount, a camera mount, a fishing pole holder, a bicycle holder, a step, a cargo basket, a tie down point, a jerry can, a spare tire mount, a winch, a wireless internet transmitter, a solar panel, a light pole, a pet containment anchor, an awning, an umbrella stand, a table, a hammock, a seating device, a sink device, a grill, a vise, a shower module, or a toilet module and combinations thereof.

In certain embodiments having a second adapter, the second adapter may include a second central plate, a second adapter upper plate, a second adapter upward facing tab, a second adapter first downward facing tab, a second adapter second downward facing tab, a second adapter lower plate, and a second adapter lower mounting panel. The second central plate may have a plurality of clevis mounting holes configured to connect the second clevis to the second central plate. The second adapter upper plate may extend inwardly from a second central plate upper edge. The second adapter upward facing tab may extend upwardly from a second adapter upper plate terminal edge and may form the second mounting surface. The second adapter first downward facing tab may extend downwardly from a second adapter upper plate terminal edge first end and may have at least one second adapter first downward facing tab mounting hole. The second adapter second downward facing tab may extend downwardly from a second adapter upper plate terminal edge second end and may have at least one second adapter second downward facing tab mounting hole. The second adapter lower plate may extend inwardly from a second central plate lower edge. The second adapter lower mounting panel may extend downwardly from a second adapter lower plate terminal edge and may have at least one second adapter lower mounting panel mounting hole.

In some embodiments having a second mounting bracket, the second mounting bracket may include at second mid-plate, a second bottom plate, and a second top plate. The second bottom plate may extend downwardly from a second mid-plate lower edge and may have at least one second bottom plate mounting hole configured to connect the second clevis to the second mounting bracket. The second top plate may extend upwardly from a second mid-plate upper edge and may have at least one second top plate mounting hole configured to connect to the second mounting surface.

In certain embodiments, the device may be a bull bar device having a bar assembly having one or more bars, a bar assembly first attachment point, and a bar assembly second attachment point. In such embodiments, the first mid-plate of the first mounting bracket may be attached to the bar assembly first attachment point. The second mid-plate of the second mounting bracket may be attached to the bar assembly second attachment point. The first adapter upward facing tab may include at least one first bar assembly mounting hole disposed in the first mounting surface. The second adapter upward facing tab may include at least one second bar assembly mounting hole disposed in the second mounting surface.

In some embodiments where the device is a bull bar device, the bar assembly may include a substantially C-shaped bar extending from the bar assembly first attachment point to the bar assembly second attachment point. In other embodiments, the bar assembly may include a first upright, a second upright, a lower cross member, an upper cross member, a first end hoop, and a second end hoop. The first upright may extend from the bar assembly first attachment point. The second upright may extend from the bar assembly second attachment point. The lower cross member may extend between a first upright medial position and a second upright medial position. The upper cross member may extend between a first upright terminal end and a second upright terminal end. The first end hoop may have a substantially C-shaped profile extending between the first upright medial position and the first upright terminal end. The second end hoop may have a substantially C-shaped profile extending between the second upright medial position and the second upright terminal end.

### BRIEF DESCRIPTION OF FIGURES

FIG. 1 is a side view of a mounting portion of an embodiment of a system for connecting a device to the front of a vehicle.

FIG. 2 is a top view of a portion of an embodiment of a system for connecting a device to the front of a vehicle.

FIG. 3 is an isometric view of an adapter for an embodiment of a system for connecting a device to the front of a vehicle.

FIG. 4 is an isometric view of a mounting bracket for an embodiment of a system for connecting a device to the front of a vehicle.

FIG. 5 is a front view of an embodiment of a bull bar device to be connected to the front of a vehicle using the system.

FIG. 6 is a front view of an embodiment of a bull bar device to be connected to the front of a vehicle using the system.

FIG. 7 is an exploded isometric view of an embodiment of a system for connecting a bull bar device to the front of a vehicle.

FIG. 8 is an assembled isometric view of an embodiment of a system for connecting a bull bar device to the front of a vehicle.

FIG. 9 is an exploded isometric view of an embodiment of the front of a vehicle with a system for connecting a bull bar device to the vehicle.

FIG. 10 is an assembled isometric view of an embodiment of the front of a vehicle with a system connecting a bull bar device to the vehicle.

FIG. 11 is a cross section view of a portion of an embodiment of a system connecting a bull bar device to the front of a vehicle.

FIG. 12 is an exploded isometric view of an embodiment of a system for connecting a license plate holder to the front of a vehicle.

FIG. 13 is an exploded isometric view of an embodiment of a system for connecting D-rings to the front of a vehicle.

FIG. 14 is an exploded isometric view of an embodiment of a system for connecting a light bar to the front of a vehicle.

FIG. 15 is a front view of an embodiment of a bull bar device.

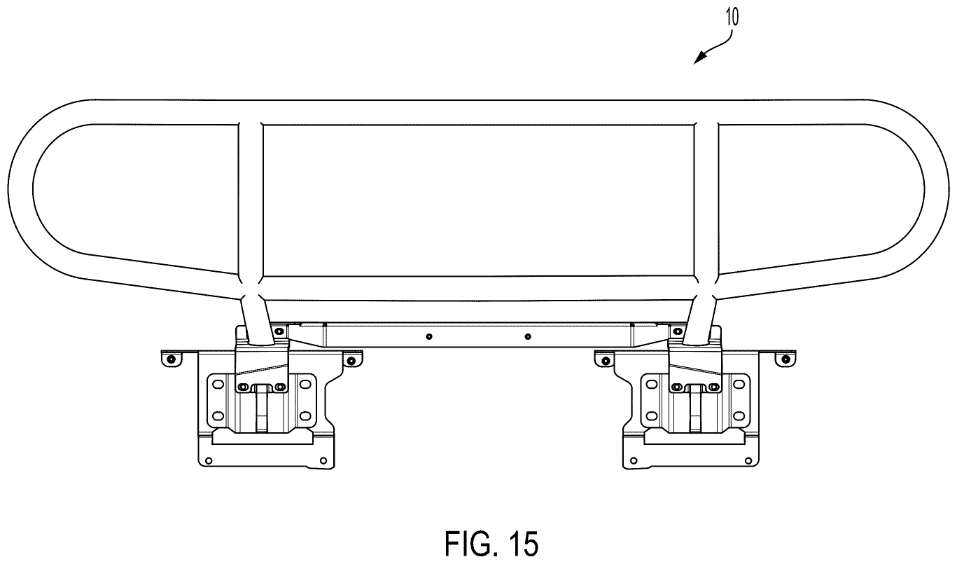

FIG. 16 is a rear view of an embodiment of a bull bar device.

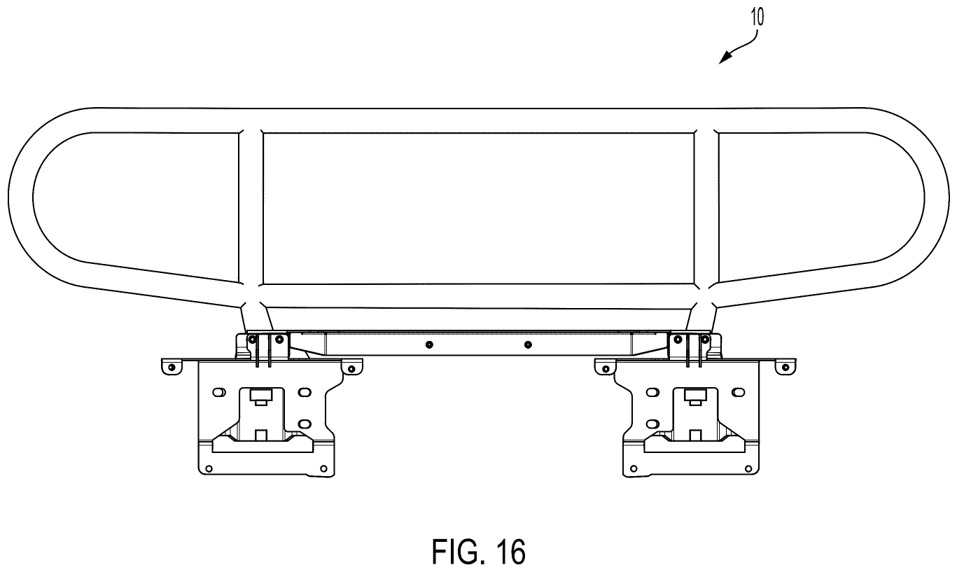

FIG. 17 is a right side view of an embodiment of a bull bar device.

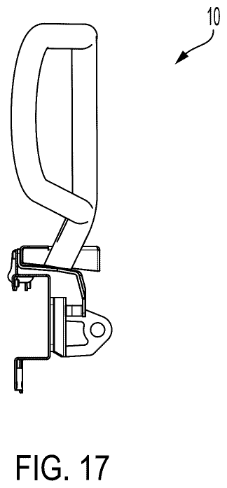

FIG. 18 is a left side view of an embodiment of a bull bar device.

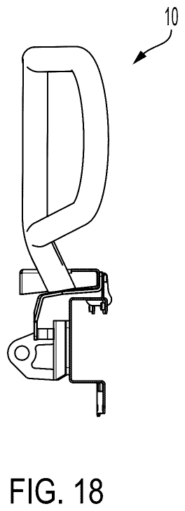

FIG. 19 is a top view of an embodiment of a bull bar device.

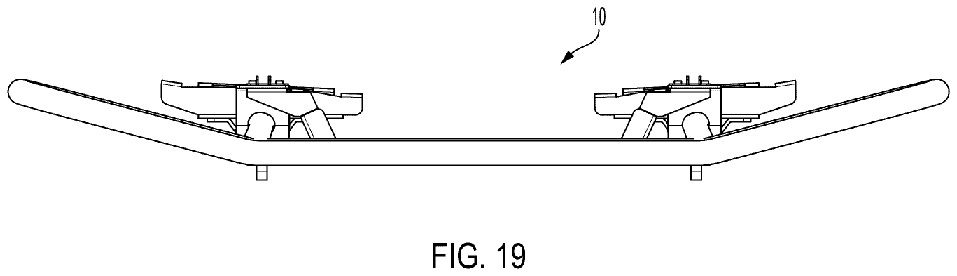

FIG. 20 is a bottom view of an embodiment of a bull bar device.

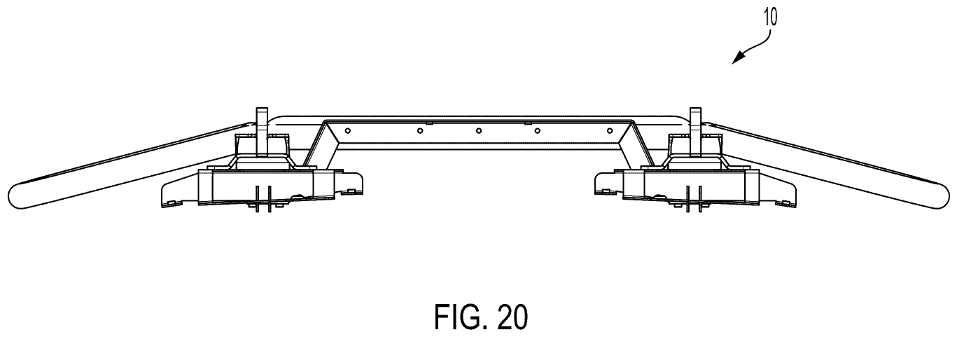

### DETAILED DESCRIPTION

Disclosed herein is a system for connecting a device to the front of a motor vehicle. The system is described below with reference to the Figures. As described herein, the following numbers refer to the following structures as noted in the Figures.
5 refers to a motor vehicle.
6 refers to a first chassis surface.
7 refers to a second chassis surface.
10 refers to a bull bar device.
100 refers to a bar assembly.
110 refers to a bar assembly first attachment point.
120 refers to a bar assembly second attachment point.
130 refers to a C-shaped bar.
140 refers to a first upright.
141 refers to a first upright medial position.
142 refers to a first upright terminal end.
150 refers to a second upright.
151 refers to a second upright medial position.
152 refers to a second upright terminal end.
160 refers to a lower cross member.
170 refers to an upper cross member.
180 refers to a first end hoop.
190 refers to a second end hoop.
200 refers to a first adapter.
210 refers to a first mounting surface.
220 refers to a first central plate.
221 refers to a first clevis mounting hole.
222 refers to a first central plate upper edge.
223 refers to a first central plate lower edge.
230 refers to a first adapter upper plate.
231 refers to a first adapter upper plate terminal edge.
232 refers to a first bar assembly mounting hole.
233 refers to a first adapter upper plate terminal edge first end.
234 refers to a first adapter upper plate terminal edge second end.
240 refers to a first adapter upward facing tab.
250 refers to a first adapter first downward facing tab.
251 refers to a first adapter first downward facing tab mounting hole.
260 refers to a first adapter second downward facing tab.
261 refers to a first adapter second downward facing tab mounting hole.
270 refers to a first adapter lower plate
271 refers to a first adapter lower plate terminal edge.
280 refers to a first adapter lower mounting panel.
281 refers to a first adapter lower mounting panel mounting hole.
300 refers to a second adapter.
310 refers to a second mounting surface.
320 refers to a second central plate.
321 refers to a second clevis mounting hole.
322 refers to a second central plate upper edge.
323 refers to a second central plate lower edge.
330 refers to a second adapter upper plate.
331 refers to a second adapter upper plate terminal edge.
332 refers to a second bar assembly mounting hole.
333 refers to a second adapter upper plate terminal edge first end.
334 refers to a second adapter upper plate terminal edge second end.
340 refers to a second adapter upward facing tab.
350 refers to a second adapter first downward facing tab.

1351 refers to a second adapter first downward facing tab mounting hole.
360 refers to a second adapter second downward facing tab.
361 refers to a second adapter second downward facing tab mounting hole.
370 refers to a second adapter lower plate
371 refers to a second adapter lower plate terminal edge.
380 refers to a second adapter lower mounting panel.
381 refers to a second adapter lower mounting panel mounting hole.
400 refers to a first mounting bracket.
410 refers to a first mid-plate.
411 refers to a first mid-plate lower edge.
412 refers to a first mid-plate upper edge.
420 refers to a first bottom plate.
421 refers to a first bottom plate mounting hole.
430 refers to a first top plate.
431 refers to a first top plate mounting hole.
500 refers to a second mounting bracket.
510 refers to a second mid-plate.
511 refers to a second mid-plate lower edge.
512 refers to a second mid-plate upper edge.
520 refers to a second bottom plate.
521 refers to a second bottom plate mounting hole.
530 refers to a second top plate.
531 refers to a second top plate mounting hole.
600 refers to a first clevis.
610 refers to a first D-ring.
620 refers to a first clevis fastener hole.
630 refers to a first clevis hole.
640 refers to a first clevis mounting bracket.
645 refers to a first clevis bracket attachment hole.
650 refers to a first device attachment hole.
700 refers to a second clevis.
710 refers to a second D-ring.
720 refers to a second clevis fastener hole
730 refers to a second clevis hole.
740 refers to a second clevis mounting bracket.
745 refers to a second clevis bracket attachment hole.
750 refers to a second device attachment hole.
800 refers to a license plate bracket.
900 refers to a light bar.
910 refers to a light bar mount.

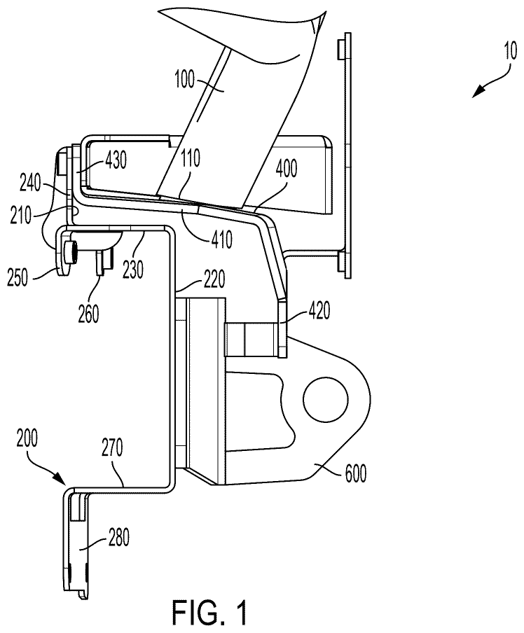

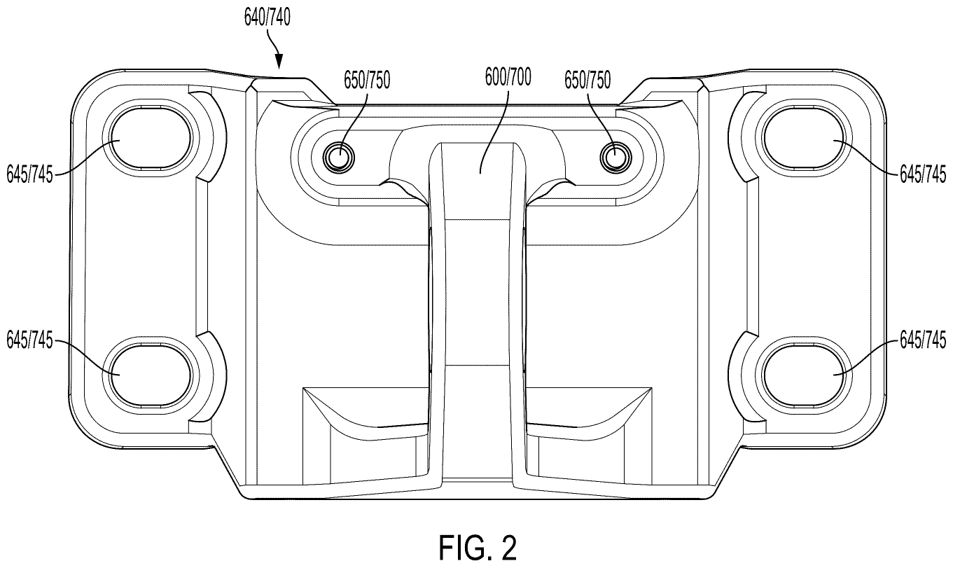

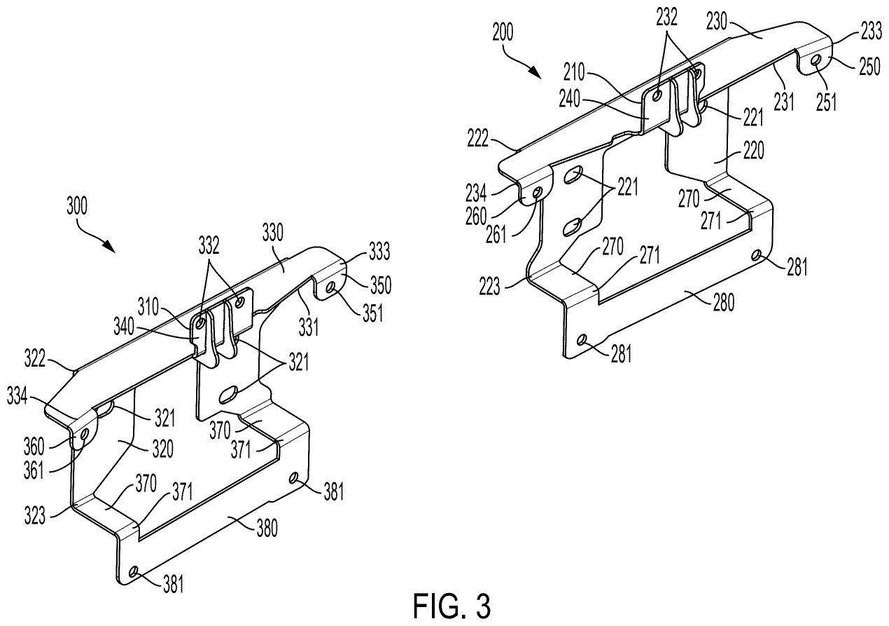

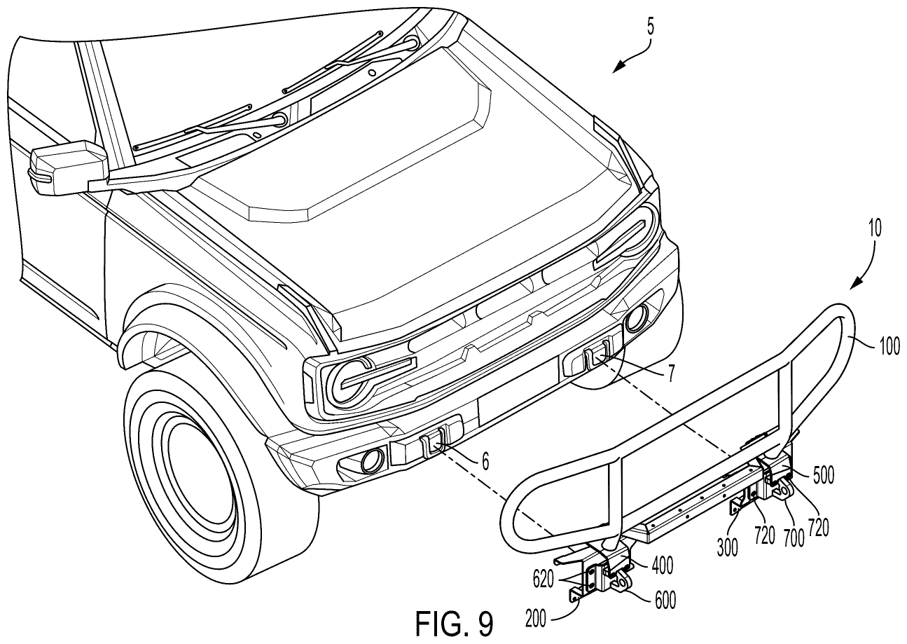

FIG. 1 illustrates a side view of an embodiment of a system for connecting a device to the front of a motor vehicle ((5) as shown in FIG. 9) which includes at least a mounting bracket (400/500) and optionally a secondary component which may be an adapter (200/300) and/or a clevis (600/700) connected to one another. While the embodiment shown in FIG. 1 illustrates three separate components (adapter, mounting bracket, and clevis) connected to one another by a series of fasteners, embodiments may exist in which one or more of the adapter, mounting bracket, and/or clevis are fabricated as a single integral piece (as shown in FIG. 2)—such as by casting. In the embodiment shown in FIG. 1, the adapter may be a first adapter (200) or a second adapter ((300) as shown in FIG. 3), the mounting bracket may be a first mounting bracket (400) or a second mounting bracket ((500) as shown in FIG. 3), and the clevis may be a first clevis (600) or a second clevis ((700) as shown in FIG. 3). For ease of understanding, it is generally considered that the first adapter, first mounting bracket, and first clevis will connect to one another forming a first attachment mechanism for connecting a device, such as a bull bar device ((10) as shown in FIG. 9) to one chassis surface ((6/7) as shown in FIG. 9) of the motor vehicle ((5) as shown in FIG. 9) while the second adapter, second mounting bracket, and second clevis will connect to one another forming a second attachment mechanism for connecting the device to a different chassis surface of the motor vehicle.

FIG. 2 illustrates the system in which the clevis (600/700) is fabricated as a single integral piece—such as by casting—along with a clevis mounting bracket (640/740). As shown in FIG. 2, the integrated clevis and clevis mounting bracket includes a plurality of clevis bracket attachment holes (645/745). Each clevis bracket attachment hole being configured to align with a clevis mounting hole ((221/321) as shown in FIG. 3) of the respective adapter ((200/300) as shown in FIG. 3) such that a fastener (i.e.—bolt, screw, rivet, or the like) can attach the clevis mounting bracket to the adapter. The integrated clevis and clevis mounting bracket further includes a plurality of device attachment holes (650/750). The device attachment holes may serve as an attachment point for connecting one or more devices to the integrated clevis and clevis mounting bracket. As shown in FIG. 2, the device mounting holes may be threaded to accept a bolt for connecting the device to the integrated clevis and clevis mounting bracket.

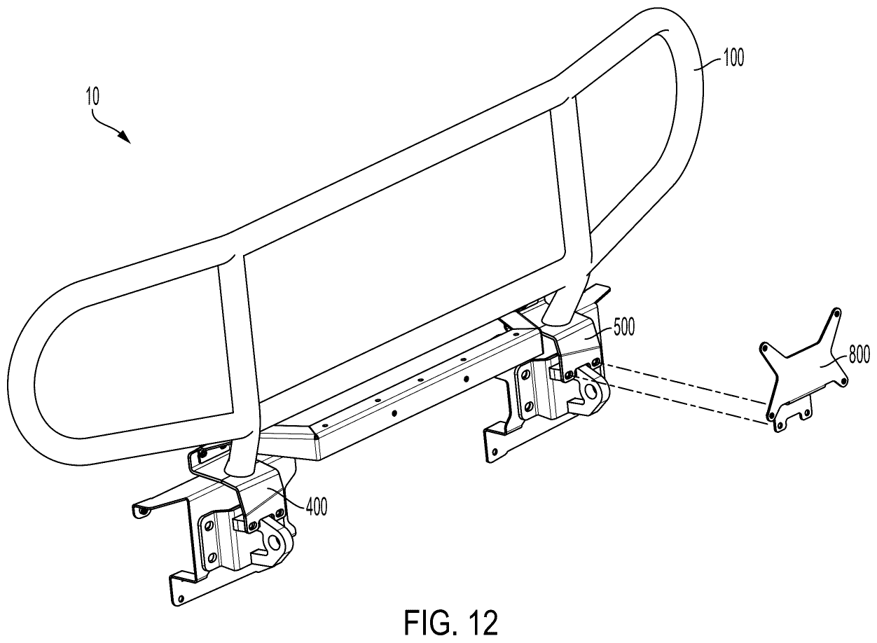

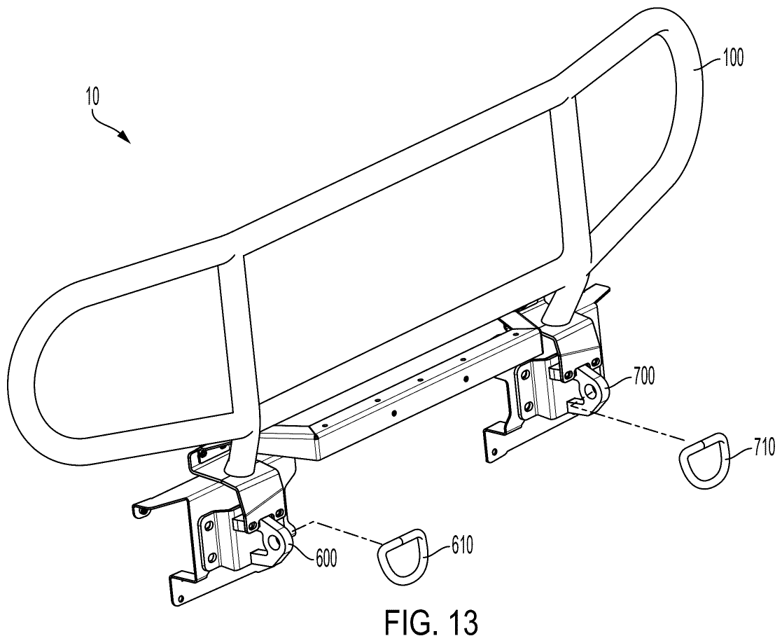

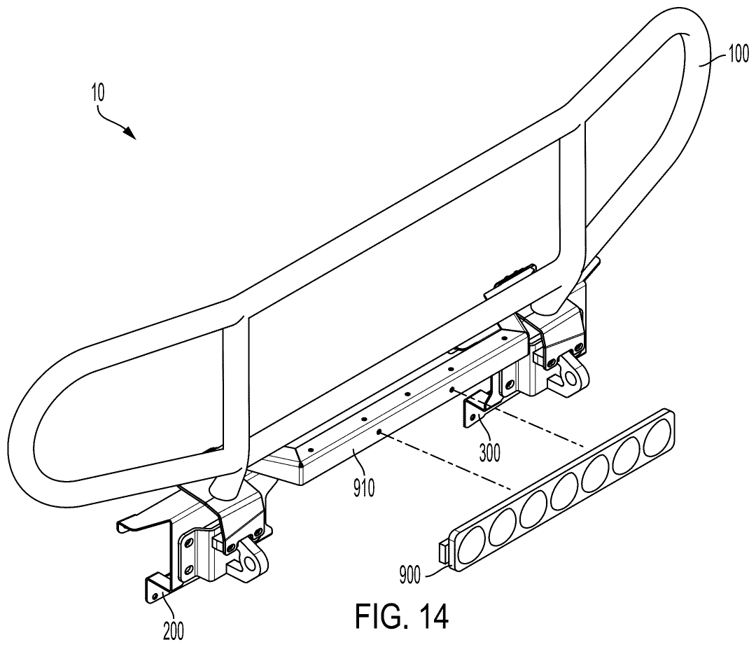

While the Figures predominantly illustrate the device as a bull bar device, other embodiments may exist. For example, in some embodiments, the device may be a license plate holder as illustrated in FIG. 12. In other embodiments, the device may be a D-ring ((610/710 as illustrated in FIG. 13). In still other embodiments, the device may be a light bar ((900) as illustrated in FIG. 14). Other devices may include a bumper mount, a recovery hook, a light pod, hitch receiver, a flag mount, a camera mount, a fishing pole holder, a bicycle holder, a step, a cargo basket, a tie down point, a jerry can, a spare tire mount, a winch, or removable items to be used such as at a camp site—examples of which may include a wireless internet transmitter, a solar panel, a light pole, a pet containment anchor, an awning, an umbrella stand, a table, a hammock, a seating device, a sink device, a grill, a vise, a shower module, or a toilet module. In summary, the device may be selected from the group consisting of a bull bar, a license plate holder, a D-ring, a light bar, a bumper mount, a recovery hook, a light pod, hitch receiver, a flag mount, a camera mount, a fishing pole holder, a bicycle holder, a step, a cargo basket, a tie down point, a jerry can, a spare tire mount, a winch, a wireless internet transmitter, a solar panel, a light pole, a pet containment anchor, an awning, an umbrella stand, a table, a hammock, a seating device, a sink device, a grill, a vise, a shower module, or a toilet module and combinations thereof.

As shown in FIG. 1, the clevis (600/700) connects to the adapter (200/300) by passing a plurality of fasteners—such as bolts, screws, rivets, or the like—through clevis fastener holes ((620/720) as shown in FIG. 9) and into (or through) a clevis mounting hole ((221/321) as shown in FIG. 3) in the central plate (220/320) of the adapter. In some embodiments, the clevis mounting hole may be threaded to allow a bolt to thread into the clevis mounting hole while—in other embodiments—the clevis mounting hole may be unthreaded allowing a bolt to pass through the clevis mounting hole and a nut to be connected to the bolt to securely fasten the clevis to the adapter.

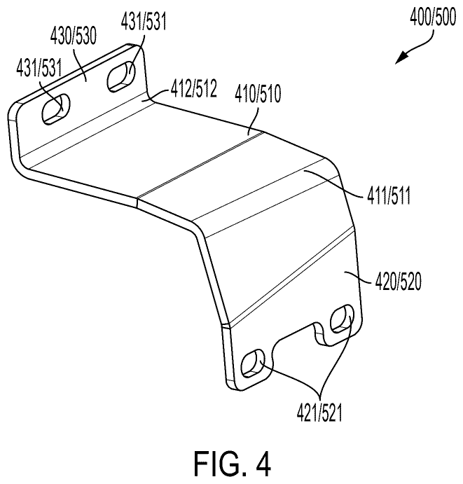

The mounting bracket (400/500) connects to the adapter (200/300) in the embodiment shown in FIG. 1 by passing fastener(s)—such as bolts, screws, rivets, or the like—through the top plate mounting hole(s) ((431/531) as shown in FIG. 4) of the mounting bracket and into the bar assembly mounting hole(s) ((232/332) as shown in FIG. 3) of the adapter. In some embodiments, the bar assembly mounting hole(s) may be threaded to allow a bolt to thread into the bar assembly mounting hole while—in other embodiments—the bar assembly mounting hole may be unthreaded allowing a bolt to pass through the bar assembly mounting hole and a nut to be connected to the bolt to securely fasten the mounting bracket to the adapter.

The mounting bracket (400/500) connects to the clevis (600/700) in the embodiment shown in FIG. 1 by passing fastener(s)—such as bolts, screws, rivets, or the like—through bottom plate mounting holes ((421/521) as shown in FIG. 4) of the mounting bracket and into holes in the clevis. In some embodiments, the holes in the clevis may be threaded to allow a bolt to thread into the hole while—in other embodiments—the holes in the clevis may be unthreaded allowing a bolt to pass through the clevis hole and a nut to be connected to the bolt to securely fasten the mounting bracket to the clevis.

FIG. 3 illustrates an isometric view of an embodiment of an adapter for the system. In the embodiment shown in FIG. 3, the adapter may be a first adapter (200) or a second adapter (300) as—in some embodiments—the first adapter and the second adapter may be identical or highly similar to one another.

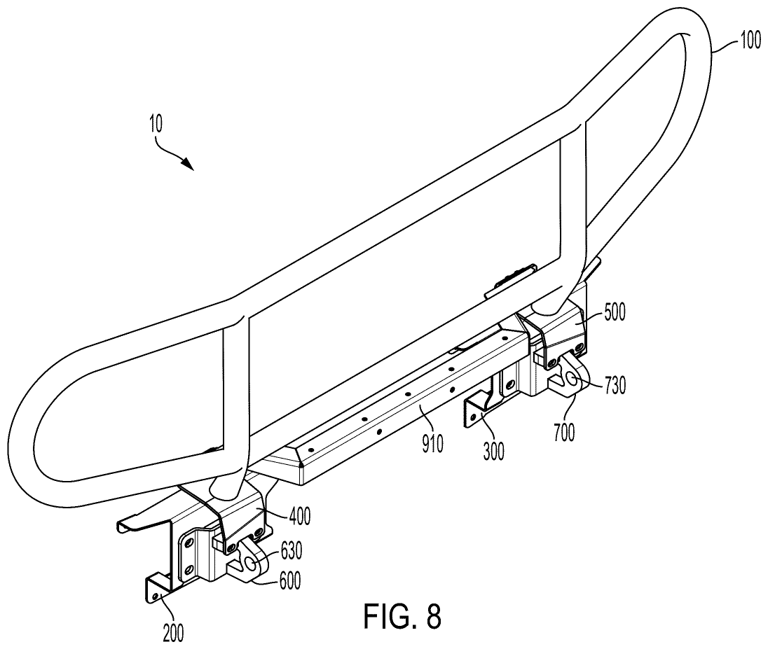

In the embodiment shown in FIG. 3, the adapter (200/300) includes a central plate (220/320). Passing through the central plate may be a plurality of clevis mounting holes (221/321) which may be configured to connect the respective clevis ((600/700) as shown in FIG. 2) to the central plate as described herein. As used herein, the term “clevis” refers to a single plate, body, and/or weldment having a perimeter defining a top surface and a bottom surface with one or more clevis holes passing therethrough. The perimeter may have a substantially triangular portion extending away from the adapter. When the clevis is the first clevis ((600) as shown in FIG. 2), the clevis will comprise at least a first clevis hole ((630) as shown in FIG. 8). Similarly, when the clevis is the second clevis ((700) as shown in FIG. 2), the clevis will comprise at least a second clevis hole ((730) as shown in FIG. 8). The clevis(es) may be fabricated of a metal material—such as steel, stainless steel, or aluminum—using any number of manufacturing techniques. In some embodiments, the clevis(es) will be fabricated of a single piece of material which is cut, bent, and drilled to form the various features described herein. In other embodiments, the various features of the clevis(es) may be fabricated individually and joined to one another, such as by welding. In still other embodiments, the clevis(es) may be manufactured of a single integral piece of material, such as by casting.

Extending inwardly from a central plate upper edge (222/322) may be an adapter upper plate (230/330). The adapter upper plate may include an adapter upward facing tab (240/340) extending upwardly from an adapter upper plate terminal edge (231/331). The adapter upward facing tab may form the mounting surface (210/310) to which the mounting bracket ((400/500) as shown in FIG. 1) is connected. At least one bar assembly mounting hole (232/332) may be disposed in the mounting surface allowing for the adapter (200/300) to connect to the mounting bracket as described herein.

The adapter upper plate (230/330) may also include an adapter first downward facing tab (250/350) extending downwardly from an adapter upper plate terminal edge first end (233/333) and having at least one adapter first downward facing tab mounting hole (251/351) passing therethrough. The adapter upper plate may also include an adapter second downward facing tab (260/360) extending downwardly from an adapter upper plate terminal edge second end (234/334) and having at least one adapter second downward facing tab mounting hole (261/361) passing therethrough. The adapter downward facing tabs may be used to connect the device (in particular when the device is a bull bar device (10) as shown in FIG. 9) to the motor vehicle ((5) as shown in FIG. 9) as described herein.

Extending inwardly from a central plate lower edge (223/323) may be an adapter lower plate (270/370). The adapter lower plate may include an adapter lower mounting panel (280/380) extending downwardly from an adapter lower plate terminal edge (271/371) and having at least one adapter lower mounting panel mounting hole (281/381) passing therethrough. The adapter lower mounting panel may be used—with or without the adapter downward facing tabs—to connect the device (in particular when the device is a bull bar device ((10) as shown in FIG. 9) to the motor vehicle ((5) as shown in FIG. 9) as described herein.

The adapter (200/300) may be fabricated of a metal material—such as steel, stainless steel, or aluminum—using any number of manufacturing techniques. In some embodiments, the adapter will be fabricated of a single piece of material which is cut, bent, and drilled to form the various features described herein. In other embodiments, the various plates, panels, and tabs of the adapter may be fabricated individually and joined to one another, such as by welding. In still other embodiments, the adapter may be manufactured of a single integral piece of material, such as by casting.

FIG. 4 illustrates an isometric view of an embodiment of a mounting bracket for the system. In the embodiment shown in FIG. 4, the mounting bracket may be a first mounting bracket (400) or a second mounting bracket (500) as—in some embodiments—the first mounting bracket and the second mounting bracket may be identical or highly similar to one another.

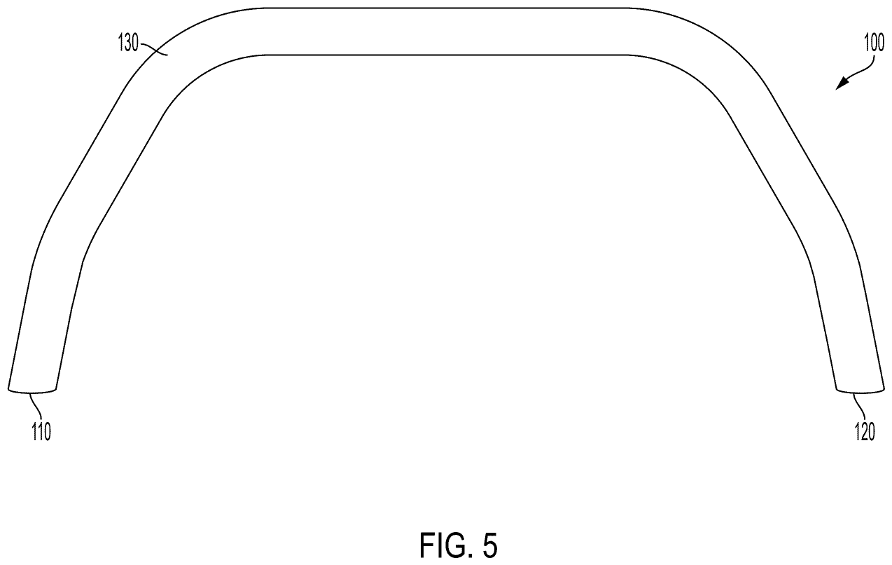

In the embodiment shown in FIG. 4, the mounting bracket (400/500) includes a mid-plate (410/510) attached to the respective bar assembly attachment point ((110/120) as shown in FIG. 5) as described herein. A bottom plate (420/520) extends downwardly from a mid-plate lower edge (411/511) and includes at least one bottom plate mounting hole (421/521) passing therethrough. The bottom plate serves to connect the respective clevis (600/700) to the mounting bracket as described herein.

A top plate (430/530) extends upwardly from a mid-plate upper edge (412/512) of the mounting bracket (400/500) and includes at least one top plate mounting hole (431/531) passing therethrough as shown in FIG. 4. The top plate serves to connect the mounting bracket to the respective mounting surface ((210/310) as shown in FIG. 1) of the adapter ((200/300) as shown in FIG. 1) as described herein.

The mounting bracket (400/500) may be fabricated of a metal material—such as steel, stainless steel, or aluminum—using any number of manufacturing techniques. In some embodiments, the mounting bracket will be fabricated of a single piece of material which is cut, bent, and drilled to form the various features described herein. In other embodiments, the various plates of the mounting bracket may be fabricated individually and joined to one another, such as by welding. In still other embodiments, the mounting bracket may be manufactured of a single integral piece of material, such as by casting.

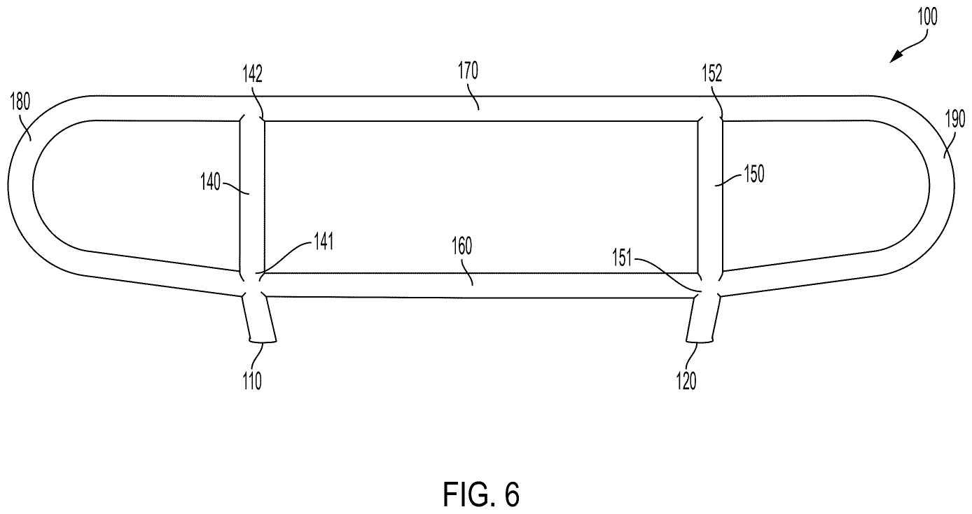

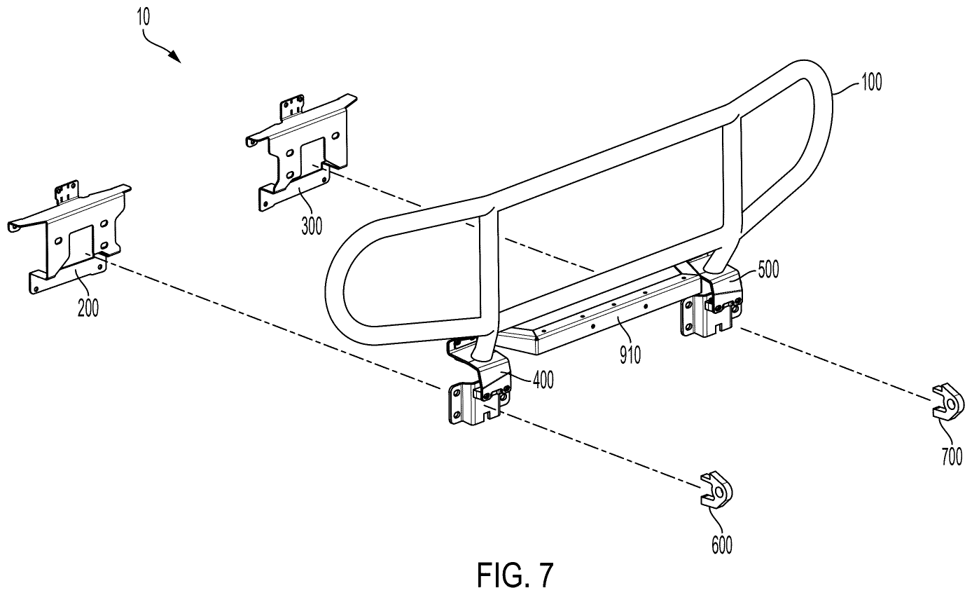

In some embodiments, the device connected to the front of the vehicle by the system may be a bull bar device (10). FIG. 5 and FIG. 6 illustrate alternative embodiments of a bar assembly (100) for a bull bar device. As shown in FIGS. 5 and 6, the various embodiments of a bar assembly may include a bar assembly first attachment point (110) and a bar assembly second attachment point (120). When assembled, the bar assembly first attachment point may connect to the first mounting bracket ((400) as shown in FIG. 7) while the bar assembly second attachment point may connect to the second mounting bracket ((500) as shown in FIG. 8). The connection between the bar assembly attachment point(s) and their respective mounting bracket may take many forms. In some embodiments, the connection may be a permanent connection such as that created by welding the bar assembly attachment point(s) to their respective mounting bracket. In other embodiments, the connection may be a removable connection such as that created by fastening the bar assembly attachment point(s) to their respective mounting brackets using one or more bolts, screws, rivets, clamps, or the like. While alternative embodiments are shown in FIGS. 5 and 6, other embodiments may exist.

In the embodiment shown in FIG. 5, the bar assembly (100) includes a substantially C-shaped bar (130) spanning between the bar assembly first attachment point (110) and the bar assembly second attachment point (120). The C-shaped profile of the bar assembly shown in FIG. 5 may be created in a number of ways. In some embodiments, the C-shaped profile may be created starting from a single length of bar material which is cut and bent into the C-shaped profile using traditional cutting and bending equipment. In other embodiments, the various sections of the C-shaped bar may be pre-fabricated and joined to one another, such as by welding. Alternatively, in some embodiments, the bar assembly shown in FIG. 5 may be manufactured of a single integral piece of material, such as by casting.

In the embodiment shown in FIG. 6, the bar assembly (100) includes a first upright (140), a second upright (150), a lower cross member (160), an upper cross member (170), a first end hoop (180), and a second end hoop (190). The first upright extending from the bar assembly first attachment point (110) with the second upright extending from the bar assembly second attachment point (120). The lower cross member extends between a first upright medial position (141) and a second upright medial position (151). In some embodiments, the first upright medial position and the second upright medial position may be located equidistant between the bar assembly first attachment point and the first upright terminal end (142) and the between the bar assembly second attachment point and the second upright terminal end (152) respectively. However, it is preferred that the first upright medial position and the second upright medial position be located closer to the respective bar assembly attachment point(s) (110/120) than the respective upright terminal end(s) (142/152) as shown in FIG. 6. The upper cross member extends between the first upright terminal end and the second upright terminal end. The first end hoop may have a substantially C-shaped profile extending between the first upright medial position and the first upright terminal end while the second end hoop may have a substantially C-shaped profile extending between the second upright medial position and the second upright terminal end.

The embodiment of the bar assembly shown in FIG. 6 may be manufactured using a variety of manufacturing techniques. Preferably, the bar assembly shown in FIG. 6 will be manufactured by cutting (and optionally bending) the various sections—including the first upright (140), the second upright (150), the lower cross member (160), the upper cross member (170), the first end hoop (180), and the second end hoop (190) to shape and joining them together, such as by welding or by connecting the sections to one another using fasteners such as bolts, screws, rivets, clamps, or the like. Alternatively, in some embodiments, the bar assembly shown in FIG. 6 may be manufactured of a single integral piece of material, such as by casting.

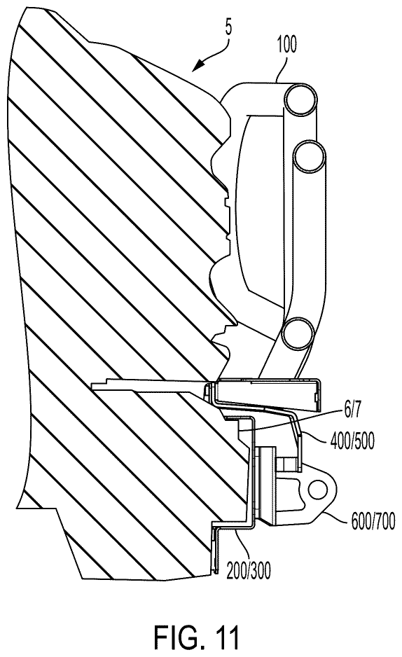

FIG. 7 illustrates an embodiment of a bull bar device (10) for a motor vehicle ((5) as shown in FIG. 9) in exploded isometric view with FIG. 8 illustrating an assembled version thereof. As shown in FIGS. 7 and 8, the bull bar device may include a bar assembly (100), a first adapter (200), a second adapter (300), a first mounting bracket (400), a second mounting bracket (500), a first clevis (600), and a second clevis (700). The first adapter being configured to connect to a first chassis surface ((6) as shown in FIG. 11) of the motor vehicle with the second adapter being configured to connect to a second chassis surface ((7) as shown in FIG. 11) of the motor vehicle.

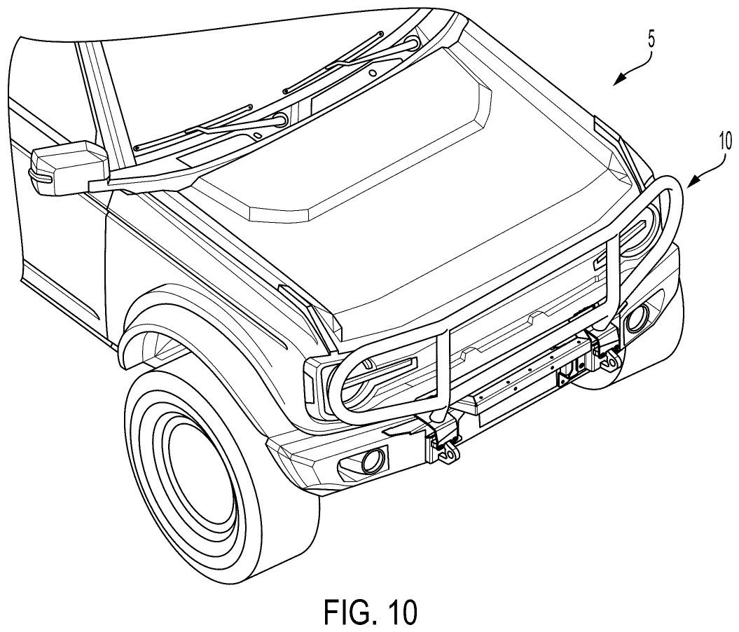

FIG. 9 illustrates an exploded view of a motor vehicle (5) and a system including a bull bar device (10) with FIG. 10 illustrating an assembled view thereof. As shown in FIG. 9, the motor vehicle may include two chassis surfaces referred to herein as a first chassis surface (6) and a second chassis surface (7). The first adapter (200) being configured to connect to the first chassis surface with the second adapter (300) being configured to connect to the second chassis surface. In some exemplary embodiments—such as those shown in FIG. 9 and FIG. 10—the first chassis surface and/or the second chassis surface may be a position on the chassis to which the vehicle's front bumper connects to the vehicle's chassis.

FIG. 11 illustrates a cross section view of the bull bar device (10) connected to the motor vehicle (5) which may be either the first adapter (200) connected to the first chassis surface (6) or the second adapter (300) connected to the second chassis surface (7). The respective chassis surfaces may include a plurality of mounting holes. The adapter is configured such that the central plate ((220/320) as shown in FIG. 3) abuts against an outward facing portion of the vehicle's chassis, the adapter upper plate ((230/330) as shown in FIG. 3) abuts against top surface of a portion of the vehicle's chassis adjacent to the outward facing portion, and the adapter downward facing tabs ((250/260/350/360) as shown in FIG. 3) abut against an inward facing portion of the vehicle's chassis. A fastener—such as a bolt, screw, rivet, or the like—may then pass through the adapter downward facing tab mounting hole(s) ((251/261/351/361) as shown in FIG. 3) and into the upper mounting holes in the chassis surface to secure the adapter to the vehicle's chassis.

In addition, or instead of, connecting the adapter downward facing tabs ((250/260/350/360) as shown in FIG. 3) to the chassis surface (6/7), the adapter lower mounting panel ((280/380) as shown in FIG. 3) of the adapter (200/300) may be used to connect the adapter to the vehicle's chassis. In such embodiments, the respective chassis surfaces may include a plurality of lower mounting holes. The adapter lower mounting panel may abut against a portion of an outward facing surface of the vehicle's chassis, and a fastener—such as a bolt, screw, rivet, or the like—may pass through the adapter lower mounting panel mounting hole(s) ((281/381) as shown in FIG. 3) and into the lower mounting holes in the chassis surface to secure the adapter to the vehicle's chassis.

FIG. 12 illustrates an exemplary embodiment in which the system is used to connect a license plate bracket (800) allowing a user to connect an official state license plate or other license plate replacement to their vehicle. While FIG. 12 illustrates the system including both a license plate bracket and a bull bar device (10), one will recognize that the license plate bracket may be included alone with or without the bull bar device. When present, the license plate bracket may connect to and extend from the first mounting bracket (400) or the second mounting bracket (500). The connection between the license plate bracket and the mounting bracket may be a permanent connection, such as by welding the license plate bracket to the mounting bracket or manufacturing the license plate bracket and the mounting bracket of a single integral piece of material. Alternatively, the connection between the license plate bracket and the mounting bracket may be a removable connection formed by one or more fasteners such as bolts (with or without nuts), screws, rivets, clamps, or the like.

Preferably, the license plate bracket will be fabricated of a metal material—such as steel, stainless steel, or aluminum—using any number of manufacturing techniques. In some embodiments, the license plate bracket will be fabricated of a single piece of material which is cut, bent, and drilled to form the various features described herein. In other embodiments, the various pieces of the license plate bracket may be fabricated individually and joined to one another, such as by welding. In still other embodiments, the license plate bracket may be manufactured of a single integral piece of material, such as by casting.

FIG. 13 illustrates an exemplary embodiment in which the device is one or more D-rings. While FIG. 13 illustrates the system including both D-rings and a bull bar device (10), one will recognize that the D-rings may be included alone with or without the bull bar device. In the embodiment shown in FIG. 13, two D-rings—referred to herein as a first D-ring (610) and a second D-ring (710) are present. The first D-ring being connected to the first clevis (600) while the second D-ring is connected to the second clevis (700). The connection between the D-rings and the respective clevises will preferably be a removable connection formed by one or more fasteners such as bolts (with or without nuts), screws, rivets, clips, clamps, or the like. While FIG. 13 illustrates the D-rings as a unitary piece of tube or bar which has been bent into the shape of a D with a split between the two ends, other embodiments may exist. For example, the D-ring(s) may be cast as a singular member having a continuous outer perimeter with no split, and one or more attachment pins extending from the D-ring that is configured to connect to the respective clevise(s).

Preferably, the D-ring(s) will be fabricated of a metal material—such as steel, stainless steel, or aluminum—using any number of manufacturing techniques. In some embodiments, one or more components of a D-ring may be fabricated of a single piece of material which is milled, cut, bent, and/or drilled to form the various features described herein. In other embodiments, one or more pieces of a D-ring may be fabricated individually and joined to one another, such as by welding or by way of one or more fasteners. In still other embodiments, components of a D-ring may be manufactured of a single integral piece of material, such as by casting.

FIG. 14 illustrates an exemplary embodiment in which the device is a light bar (900). While FIG. 14 illustrates the system including both a light bar and a bull bar device (10), one will recognize that the light bar may be included alone with or without the bull bar device. When present, the light bar may be configured to connect to and extend between the first adapter (200) and the second adapter (300) and provide a light source which is directed away from the vehicle to illuminate oncoming surfaces. In some embodiments, the light bar will be configured to connect to an (optional) light bar mount (910) which extends between the first adapter and the second adapter as shown in FIG. 14. In some embodiments, the light bar mount may also (or alternatively) be configured to mount a license plate to the bull bar device. The light bar may include a housing for a plurality of lighting elements—such as light-emitting diodes (LEDs)—which are electrically connected to a power source within the vehicle. Such power source may include the vehicle's battery or a secondary battery designated for providing power to the lighting elements. In some embodiments, a switch may be electrically connected—via hard wire or wireless communication systems such as blue tooth—to the light bar which allows a user to turn the light bar on or off by closing or opening a circuit between the power source and the lighting elements. In some embodiments, such as shown in FIG. 14, the light bar may be in the form of a single housing with a plurality of lighting elements housed therein. Alternatively, the light bar may be in the form of a plurality of housings—sometimes referred to as “pods”—with each individual housing containing one or more lighting elements.

The embodiments of a system for connecting a device to the front of a vehicle described herein may be configured to connect to a vehicle's chassis without modifying the vehicle's bumper, grill, or front chassis members—thereby maintaining the vehicle's structural integrity and safety features in the event high speed impacts. In addition, the adapters and mounting brackets used to connect the device to the vehicle do not require elimination of clevises, D-rings, or the like which may assist in vehicle recovery.

While the system for connecting a device to the front of a vehicle has been described as having one or more exemplary designs, the present system may be further modified within the spirit and scope of this disclosure. This application is therefore intended to cover any variations, uses, or adaptations of the system using their general principles.

What is claimed is:

1. A system for connecting a device to the front of a motor vehicle (5), said system comprising:
a first mounting bracket (400) configured to connect to a first chassis surface (6) of the motor vehicle or a first mounting surface of a secondary component.

2. The system of claim 1, wherein the first mounting bracket comprises:
a first mid-plate (410);
a first bottom plate (420) extending downwardly from a first mid-plate lower edge (411) and having at least one first bottom plate mounting hole (421); and
a first top plate (430) extending upwardly from a first mid-plate upper edge (412) and having at least one first top plate mounting hole (431) configured to connect to the first chassis surface or first mounting surface.

3. The system of claim 1, wherein the secondary component is a first adapter configured to connect to the first chassis surface of the motor vehicle and having the first mounting surface.

4. The system of claim 3, wherein the first adapter comprises:
a first central plate (220);
a first adapter upper plate (230) extending inwardly from a first central plate upper edge (222);
a first adapter upward facing tab (240) extending upwardly from a first adapter upper plate terminal edge (231) and forming the first mounting surface;
a first adapter first downward facing tab (250) extending downwardly from a first adapter upper plate terminal edge first end (233) and having at least one first adapter first downward facing tab mounting hole (251);
a first adapter second downward facing tab (260) extending downwardly from a first adapter upper plate terminal edge second end (234) and having at least one first adapter second downward facing tab mounting hole (261);
a first adapter lower plate (270) extending inwardly from a first central plate lower edge (223); and
a first adapter lower mounting panel (280) extending downwardly from a first adapter lower plate terminal edge (271) and having at least one first adapter lower mounting panel mounting hole (281).

5. The system of claim 3, wherein the device includes a license plate bracket (800) connected to and extending from the first adapter.

6. The system of claim 3, wherein the device includes a light pod connected to and extending from the first adapter.

7. The system of claim 3, wherein the secondary component includes a first clevis connected between the first adapter and the first mounting bracket.

8. The system of claim 7, wherein the device includes a first D-ring (610) connected to the first clevis.

9. The system of claim 7, wherein the first adapter, the first mounting bracket, and the first clevis are integrally connected to one another.

10. The system of claim 7, further comprising:
a second adapter (300) configured to connect to a second chassis surface (7) of the motor vehicle and having a second mounting surface (310);
a second mounting bracket (500) configured to connect to the second mounting surface; and
a second clevis (700) connected between the second adapter and the second mounting bracket.

11. The system of claim 10, wherein the device includes a second D-ring (710) connected to the second clevis.

12. The system of claim 10, wherein the device includes a light bar (900) connected to and extending between the first adapter and the second adapter.

13. The system of claim 10, wherein the device is selected from the group consisting of a bull bar, a license plate holder, a D-ring, a light bar, a bumper mount, a recovery hook, a light pod, hitch receiver, a flag mount, a camera mount, a fishing pole holder, a bicycle holder, a step, a cargo basket, a tie down point, a jerry can, a spare tire mount, a winch, a wireless internet transmitter, a solar panel, a light pole, a pet containment anchor, an awning, an umbrella stand, a table, a hammock, a seating device, a sink device, a grill, a vise, a shower module, or a toilet module and combinations thereof.

14. The system of claim 10, wherein the second adapter comprises:
a second central plate (320) having a plurality of clevis mounting holes (321) configured to connect the second clevis to the second central plate;
a second adapter upper plate (330) extending inwardly from a second central plate upper edge (322);
a second adapter upward facing tab (340) extending upwardly from a second adapter upper plate terminal edge (331) and forming the second mounting surface;
a second adapter first downward facing tab (350) extending downwardly from a second adapter upper plate terminal edge first end (333) and having at least one second adapter first downward facing tab mounting hole (351);
a second adapter second downward facing tab (360) extending downwardly from a second adapter upper plate terminal edge second end (334) and having at least one second adapter second downward facing tab mounting hole (361);
a second adapter lower plate (370) extending inwardly from a second central plate lower edge (323); and
a second adapter lower mounting panel (380) extending downwardly from a second adapter lower plate terminal edge (371) and having at least one second adapter lower mounting panel mounting hole (381).

15. The system of claim 10, wherein the second mounting bracket comprises:
a second mid-plate (510);
a second bottom plate (520) extending downwardly from a second mid-plate lower edge (511) and having at least one second bottom plate mounting hole (521) configured to connect the second clevis to the second mounting bracket; and
a second top plate (530) extending upwardly from a second mid-plate upper edge (512) and having at least one second top plate mounting hole (531) configured to connect to the second mounting surface.

16. The system of claim 10, wherein the second adapter, the second mounting bracket, and the second clevis are integrally connected to one another.

17. The system of claim 10, wherein the device is a bull bar device (10) comprising a bar assembly (100) having one or more bars, a bar assembly first attachment point (110), and a bar assembly second attachment point (120), and wherein:
the first mid-plate of the first mounting bracket is attached to the bar assembly first attachment point;
the second mid-plate of the second mounting bracket is attached to the bar assembly second attachment point;
the first adapter upward facing tab includes at least one first bar assembly mounting hole (232) disposed in the first mounting surface; and
the second adapter upward facing tab includes at least one second bar assembly mounting hole (332) disposed in the second mounting surface.

18. The system of claim 17, wherein the bar assembly comprises a substantially C-shaped bar (130) extending from the bar assembly first attachment point to the bar assembly second attachment point.

19. The system of claim 18, wherein the bar assembly comprises:
a first upright (140) extending from the bar assembly first attachment point;
a second upright (150) extending from the bar assembly second attachment point;
a lower cross member (160) extending between a first upright medial position (141) and a second upright medial position (151);
an upper cross member (170) extending between a first upright terminal end (142) and a second upright terminal end (152);
a first end hoop (180) having a substantially C-shaped profile extending between the first upright medial position and the first upright terminal end; and
a second end hoop (190) having a substantially C-shaped profile extending between the second upright medial position and the second upright terminal end.
